(19) United States
(12) Patent Application Publication
(10) Pub. No.: US 2012/0247114 A1
(43) Pub. Date: Oct. 4, 2012

(54) Water Cooling System For Intercooled Turbines

(75) Inventors: Thomas L. Pierson, Sugar Land, TX (US); Russell Thompson, Cypress, TX (US); Mark Linton, Houston, TX (US)

(73) Assignee: Turbine Air Systems Ltd., Houston, TX (US)

(21) Appl. No.: 13/076,200

(22) Filed: Mar. 30, 2011

(51) Int. Cl. F02C 7/14; F02C 7/12

(52) U.S. Cl. 60/772; 60/806

(57) ABSTRACT

An intercooled gas turbine is provided having an air cooled heat exchanger and a chiller disposed to remove heat from the cooling medium of the intercooler heat exchanger. During peak hours when the turbine is in operation, the air cooled heat exchanger is used primarily to cool the cooling medium of the intercooler heat exchanger. During off peak hours when the turbine is idle, the air cooled heat exchanger is used to remove heat from the condenser of a chiller system associated with a gas turbine inlet air cooling system. An additional liquid to liquid heat exchanger may be provided in-line between the intercooler heat exchanger and the air cooled heat exchanger to further cool the intercooler heat exchanger cooling medium using chilled water before the cooling medium passes back into the intercooler heat exchanger. The chilled water may be provided directly from the chillers, or from a thermal energy storage tank, or from the cooling coils of a turbine inlet air cooling system.

### SUMMARY OF THE INVENTION

A gas turbine system is provided in which an intercooler heat exchanger cools the compressed air between a low pressure stage and a high pressure stage in a multi-stage gas turbine. The system of the invention combines the multi-stage gas turbine having an intercooler heat exchanger disposed between compressor stages with a second heat exchanger and chiller arrangement to remove heat from the intercooler heat exchanger. The intercooler heat exchanger uses a liquid coolant which itself is then subsequently cooled by the second heat exchanger. The second heat exchanger may be, for example, a cooling tower or an air cooled heat exchanger. The second heat exchanger is also in communication with one or more chillers to cool condenser water utilized by the one or more chillers. When the turbine is in operation, the second heat exchanger functions primarily to cool the liquid coolant of the intercooler heat exchanger. When the turbine is not in operation, the second heat exchanger functions primarily to cool the condenser water.

In one embodiment, the intercooled gas turbine system is combined with a turbine inlet air cooling system. The turbine inlet air cooling system generally includes a chiller system and a thermal energy storage system (“TES”). The inlet air cooling system further includes a cooling coil to cool the inlet air to the gas turbine. The chiller system provides chilled water to the TES. The chiller system generally operates when the gas turbine is off-line or idle, i.e., off-peak hours such as night time, to charge the TES with chilled water. By operating when the gas turbine is idle, chiller system consumption of power generated by the gas turbine system is minimized and the chiller system can use the second heat exchanger (generally provided for the intercooler heat exchanger system) to reject the heat from the condensers of the chiller system. In this embodiment, since the chillers are operating when the gas turbine is idle, the second heat exchanger of the intercooler heat exchanger system is available for use with the chiller system. A cost savings may then be realized by eliminating the need for additional cooling towers or air cooled heat exchangers solely for the use of the chiller system.

Furthermore, a third heat exchanger may be provided to further aid in the cooling of the intercooler heat exchanger coolant. The third heat exchanger is a liquid to liquid heat exchanger and is disposed to receive chilled water from the chilled water system, preferably from the TES directly, or from the chiller system directly, or from the turbine inlet air cooling coils. This third heat exchanger also receives the intercooler liquid coolant exiting the second heat exchanger and uses the chilled water to further cool the liquid coolant before the liquid coolant is re-introduced back into the intercooler heat exchanger. The temperature of the liquid coolant fed to the intercooler heat exchanger may then be lowered by an amount greater than was previously possible through the use of only the second heat exchanger. This “supercooled” liquid coolant will yield even cooler temperatures of compressed air entering the higher pressure stage of the gas turbine, resulting in more efficient operation and/or greater power output of the overall system.

Because the third heat exchanger results in additional cooling of the liquid coolant being fed to the intercooler heat exchanger, the use of the third heat exchanger may permit use of a smaller size intercooler heat exchanger than would otherwise be necessary for the overall system, while still achieving the desired cooling of compressed air passing into the high pressure stage of the gas turbine. A capital cost savings may then be realized through the use of a smaller intercooler heat exchanger.

### BRIEF DESCRIPTION OF THE DRAWINGS

A more complete understanding of the present disclosure and advantages thereof may be acquired by referring to the following description taken in conjunction with the accompanying figures, wherein:

FIG. 1 is a process flow diagram of an intercooled, multi-stage gas turbine.

FIG. 2 is a process flow diagram of an intercooled, multi-stage gas turbine combined with a thermal energy storage system.

FIG. 3 is a process flow diagram illustrating inlet air cooling of an intercooled, multi-stage gas turbine combined with thermal energy storage system.

FIG. 4 is a cross-sectional view of a TES.

FIG. 5 is a process flow diagram of a charging cycle of a TES where the chiller is operating and turbine inlet cooling is off-line.

FIG. 5A is a process flow diagram of a charging cycle of a TES where the chiller is operating and turbine inlet cooling is on-line.

FIG. 5B is a process flow diagram of a charging cycle of a TES where the chiller is off-line and turbine inlet cooling is on-line.

FIG. 6 is a schematic piping arrangement for one embodiment of a heat exchanger of the invention.

FIG. 7 is a process flow diagram of an intercooled, multi-stage gas turbine utilizing chilled water in conjunction with the intercooler coolant and first, second and third heat exchangers.

FIG. 7A is a process flow diagram of an intercooled, multi-stage gas turbine utilizing chilled water in conjunction with the intercooler coolant as shown in FIG. 7, but without the third heat exchanger.

FIG. 8 is a process flow diagram illustrating inlet air cooling of an intercooled gas turbine.

FIG. 9 is a process flow diagram of a charging cycle of a TES utilizing a first and second heat exchanger where the chiller is operating and turbine inlet cooling is off-line.

FIG. 10 is a process flow diagram of a charging cycle of a TES where the intercooler is configured to operate in parallel with a turbine inlet cooling system.

FIG. 11 is a process flow diagram of a charging cycle of a TES where the intercooler is configured to operate in series with a turbine inlet cooling system.

FIG. 12 is a process flow diagram of a charging cycle of a TES in combination with an air to liquid heat exchanger.

### DETAILED DESCRIPTION

In the detailed description of the invention, like numerals are employed to designate like parts throughout. Various items of equipment, such as pipes, valves, pumps, fasteners, fittings, etc., may be omitted to simplify the description. However, those skilled in the art will realize that such conventional equipment can be employed as desired.

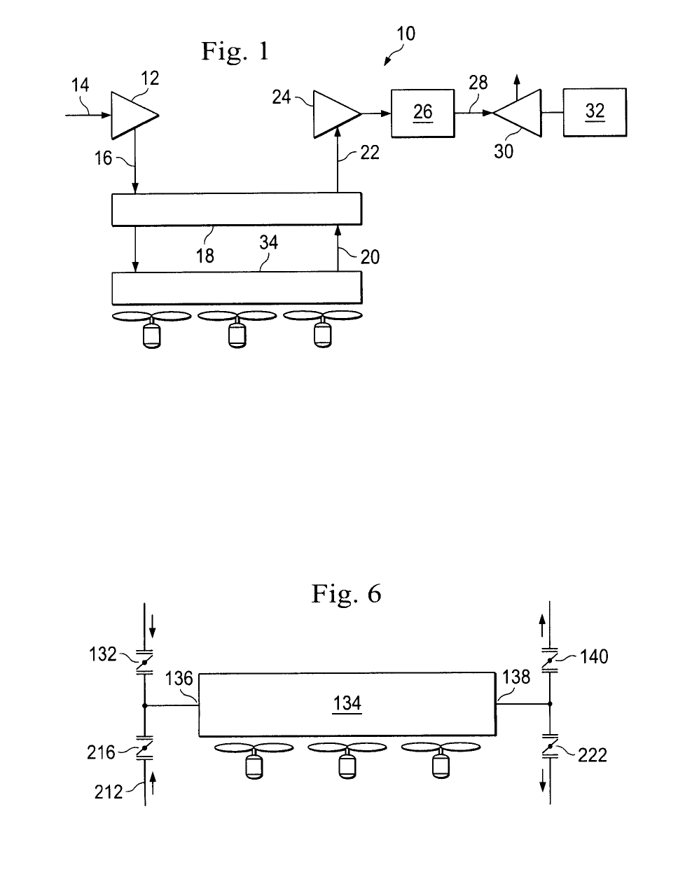

Referring to FIG. 1, in an exemplary embodiment, an intercooled gas turbine system 10 includes a low pressure compressor 12 that receives inlet air 14 and outputs low pressure compressed air 16. The low pressure compressed air 16 is then cooled in an intercooler heat exchanger 18 by intercooler cooling liquid 20 circulating therethrough. The cooled low pressure compressed air 22 is then fed into a high pressure compressor 24, where the air is further compressed and then fed into a combustor 26. From the combustor 26, the exhaust 28 drives a turbine 30 which turns a generator 32 to generate electricity. Intercooler cooling liquid 20 functions as a heat sink for low pressure compressed air 16 passing through intercooler 18. Intercooler cooling liquid 20 subsequently is cooled by a second heat exchanger 34. While second heat exchanger 34 of the invention is not limited to a particular type of heat exchanger, in the most preferred embodiments, second heat exchanger 34 may be an air cooled heat exchanger, a cooling tower, or a liquid-liquid heat exchanger if there is a liquid cooling medium available, such as, for example, water from an ocean, river or lake.

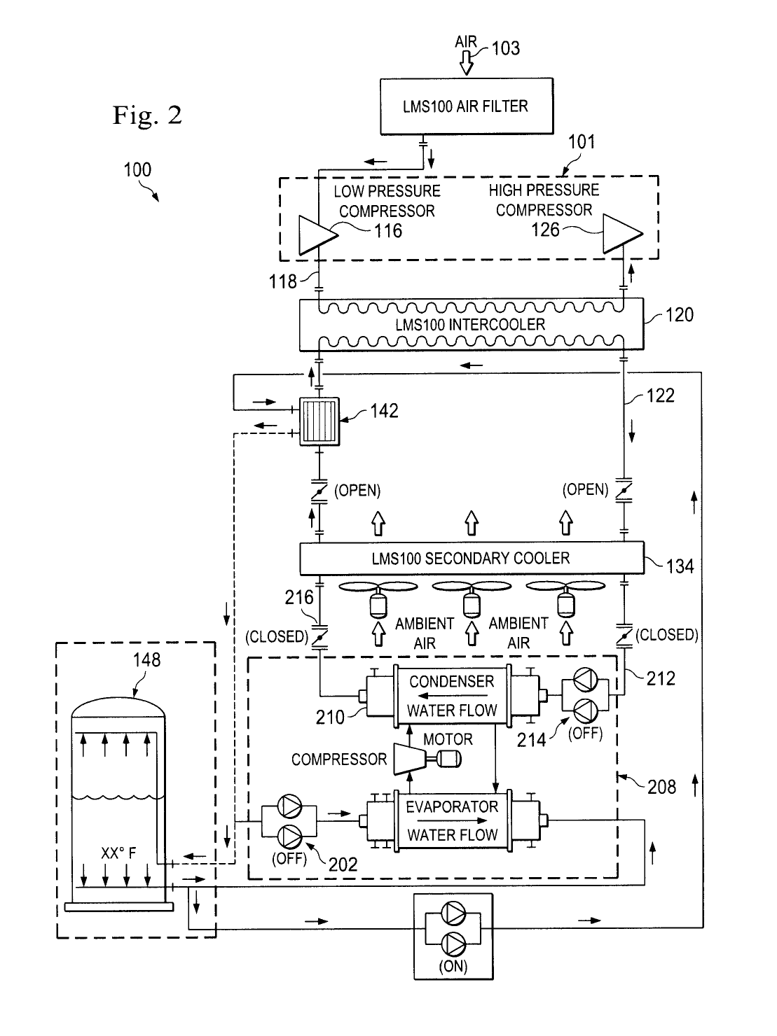

Referring to FIG. 2, in an exemplary embodiment, an intercooled gas turbine system 100 includes similar components to the intercooled gas turbine system 10 of FIG. 1, such as a low pressure compressor 116 that receives inlet air 103 and outputs low pressure compressed air 118. In FIG. 2, however, for clarity, only low pressure compressor 116 and a high pressure compressor 126 of gas turbine 101 are illustrated. The low pressure compressed air 118 is cooled in an intercooler heat exchanger 120 by intercooler cooling liquid 122 circulating therethrough. The cooled low pressure compressed air is then fed into high pressure compressor 126. Intercooler cooling liquid 122 receives heat from the low pressure compressed air 118 and in turn, intercooler cooling liquid 122 is cooled by second heat exchanger 134.

As shown, intercooled gas turbine system 100 also includes a chiller system 208. In one preferred embodiment, chiller system 208 provides chilled liquid to Thermal Energy Storage (TES) 148. Preferably, chiller system 208 operates to charge the TES 148 with chilled liquid when the turbine 101 is idle or off-line. The chilled liquid from the TES tank 148 can then be provided to a third heat exchanger 142, which is configured to further cool the intercooler cooling liquid 122 leaving the second heat exchanger 134 before the intercooler cooling liquid 122 enters the intercooler heat exchanger 120. Chiller system 208 includes one or more condensers 210 through which condenser liquid 212 is circulated by one or more condenser liquid pumps 214. The condenser liquid 212 is then cooled by second heat exchanger 134. Second heat exchanger 134 therefore provides cooling of the intercooler cooling liquid 122 during the operation of the gas turbine 101 and serves the addition function of cooling the condenser liquid 212 during the operation of the chiller system 208.

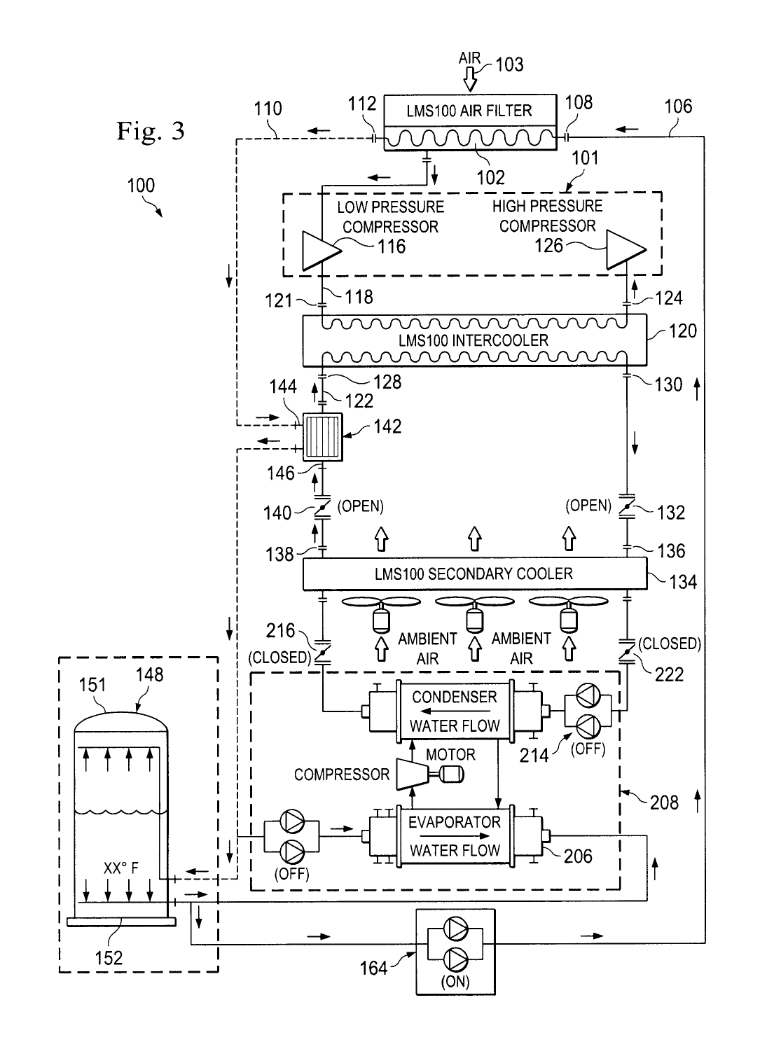

Referring to FIG. 3, in an exemplary embodiment, an intercooled gas turbine system 100 includes an inlet air cooling coil system 102 located generally adjacent the air inlet of a multi-stage gas turbine 101 (for clarity, only low pressure compressor 116 and high pressure compressor 126 are illustrated). The inlet air cooling coil system 102 receives chilled liquid at a chilled liquid inlet 108 and outputs chilled liquid at a chilled liquid outlet 112. The inlet air cooling coil system 102 may include any type of conventional cooling coils known to one of ordinary skill in the art for the cooling of inlet air 103 to gas turbines. The inlet air cooling coil system 102 utilizes heat transfer contact to cool inlet turbine air 103 passing across a set of coils having chilled liquid within the coils. In one preferred embodiment, inlet air cooling coil system 102 is capable of cooling inlet air 103 from an ambient temperature of about 80-100° F. to a lower temperature of about 45° F. In the process of inlet air cooling, cooling coil system 102 may receive inlet chilled liquid 106 at a temperature of about 36-40° F. and return chilled liquid 110 at a temperature of about 56-60° F. Those skilled in the art will appreciate that such temperature ranges are provided for illustrative purposes only and that the invention is not intended to be limited by these ranges unless particular embodiments require a particular range. Moreover, those skilled in the art will appreciate that while preferred embodiments of the invention can be practiced with modification and alteration, the above example is intended for illustrative purposes only and is not intended to limit the invention to the precise form or parameters disclosed. Many different chilled liquid flow rates and inlet cooling coil designs, liquid temperatures and air temperatures are available within the scope of this invention.

In an exemplary embodiment, the intercooled gas turbine system 100 includes ambient inlet air 103 that enters a low pressure compressor 116 of the gas turbine 101. The low pressure compressed air 118 exits the low pressure compressor 116 and enters intercooler heat exchanger 120 at low pressure compressed air inlet 121. The low pressure compressed air 118 is cooled within the intercooler heat exchanger 120 by intercooler cooling liquid 122. The low pressure compressed air 118 then exits the intercooler heat exchanger 120 at low pressure compressed air exit 124 and enters a high pressure compressor 126 of the gas turbine 101.

Still referring to FIG. 3, the intercooler cooling liquid 122 enters the intercooler heat exchanger 120 at intercooler heat exchanger cooling liquid entrance 128 and exits the intercooler heat exchanger 120 at intercooler heat exchanger cooling liquid exit 130. In an exemplary embodiment, the intercooler heat exchanger 120 may be a shell and tube type heat exchanger or a plate and frame heat exchanger, although other types of heat exchangers are contemplated within the scope of this specification. The intercooler cooling liquid 122, after exiting the intercooler heat exchanger 120, passes through valve 132 and into a second heat exchanger 134 at second heat exchanger inlet 136. In an exemplary embodiment, the second heat exchanger 134 is an air cooled heat exchanger. In another embodiment, the second heat exchanger 134 is a cooling tower. In another embodiment, the second heat exchanger 134 could be a liquid to liquid heat exchanger and use a source of water as a cooling medium, such as lake, river or ocean water. The intercooler cooling liquid 122 is cooled within the second heat exchanger 134 and then exits the second heat exchanger 134 at second heat exchanger outlet 138 and passes through a valve 140.

In one embodiment, a third heat exchanger 142 may be used to further cool intercooler cooling liquid 122, and is deployed in-line between the intercooler heat exchanger 120 and the second heat exchanger 134. Specifically, the intercooler cooling liquid 122 exits valve 140 and enters third heat exchanger 142 where the intercooler cooling liquid 122 is further cooled by a separate chilled liquid. In an exemplary embodiment, the chilled liquid is return chilled liquid 110 from cooling coils 102 and enters the third heat exchanger 142 at return chilled liquid inlet 144 and exits the third heat exchanger 142 at return chilled liquid exit 146. The intercooler cooling liquid 122 exits the third heat exchanger 142 and enters the intercooler heat exchanger 120 at the intercooler heat exchanger cooling liquid entrance 128 where the intercooler cooling liquid 122 functions to cool the low pressure compressed air 118 as discussed above. Those skilled in the art will appreciate that while the third heat exchanger 142 is described in one embodiment, it is not necessary for the practice of the invention.

In another embodiment not shown in FIG. 3, all or a portion of chilled water from the chiller system 208 and/or TES 148 (FIG. 2) may be used to cool the intercooler cooling liquid 122. For example, a portion of the inlet chilled liquid 106 may be directed to third heat exchanger 142 for cooling rather than relying upon return chilled liquid 110 exiting the cooling coils 102 for such cooling. As will be explained in greater detail below, in one embodiment chilled liquid 106 may be pumped directly from a TES 148 to the third heat exchanger 142. In another embodiment, and explained in greater detail below, chilled liquid 106 may be pumped directly from a chiller system 208 to the third heat exchanger 142.

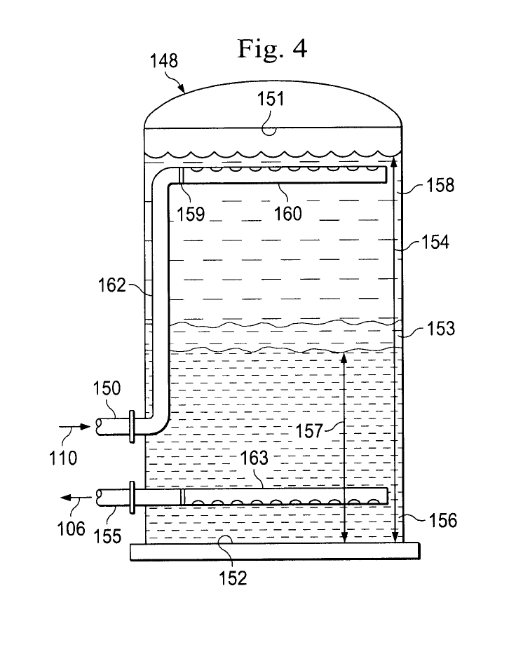

After exiting the third heat exchanger 142, the return chilled liquid 110 may then be returned to a TES 148. While the invention is not limited to any particular type of TES and encompasses various types of TESs, FIG. 4 illustrates one possible TES 148 that may be utilized with the invention. During a discharge cycle the return warmed liquid 110 flows into TES 148 via a TES connection 150 while during a charging cycle the flow reverses and the warmed liquid 110 flows out of the TES 148 via TES connection 150. The TES 148 of FIG. 4 is characterized by a top 151 and a bottom 152. The TES 148 is preferably dimensioned so that a liquid column 154 is formed within the TES 148. The liquid column 154 in the TES 148 preferably stratifies at a thermocline inside the tank 148 such as at 153 according to temperature, preferably in a relatively narrow layer of approximately 12 to 36 inches so that lower temperature liquid resides near the bottom 152 of the tank 148 and thus near the bottom 156 of the liquid column 154. The warmer temperature liquid resides near the top 158 of the liquid column 154. As the amount of discharging continues the height of the thermacline from the bottom of the tank 157 will decrease which signifies that a growing percentage of the tank is occupied by the warmer liquid rather than the colder liquid. In order to aid this stratification, the return chilled liquid 110 is preferably introduced near the top 158 of the liquid column 154, such as via a port 159. In an exemplary embodiment, an upper liquid pipe header 160 may be connected to port 159 to further aid in proper distribution of the warmed liquid 110 to the liquid column 154. In an exemplary embodiment, warmed liquid pipe 160 may include diffusers (not shown) that slow the velocity of the return warmed liquid 110 entering column 154 in order to minimize the mixing of the warmer liquid 110 with cooler liquid located further near the bottom of the column 154. In an exemplary embodiment, warmed liquid 110 enters the tank 148 via connection 150 located near the bottom 152 of the tank 148 and is piped to near the top 151 of the tank 148 through vertical riser pipe 162 and then to return pipe 160. In this manner, through the use of vertical riser pipe 162, the warmed liquid connections to the tank 148 are at a convenient ground level location, but the introduction of the warmed liquid 110 takes place near the top 158 of the liquid column 154 to aid in stratification of the water column according to temperature. In another embodiment, connection 150 may be located near the top of the tank 148, thereby eliminating the need for vertical riser pipe 162 within the tank 148.

As mentioned above, the liquid column 154 in the TES 148 may stratify according to temperature so that the lower temperature liquid resides near the bottom 152 of the tank 148 and thus near the bottom 156 of the liquid column 154. Therefore, still referring to FIGS. 3 and 4, colder chilled liquid 106 may be extracted from the bottom 156 of the liquid column 154 via a port 155 and pumped by one or more pumps 164 to the inlet air cooling coil system 102. In an exemplary embodiment, a bottom distribution pipe 163 within the bottom 156 of the column of chilled liquid 154 is connected to the port 155. The bottom distribution pipe 163, similar to the return chilled liquid pipe 160, may include diffusers (not shown) that slow the velocity of the colder chilled liquid entering bottom distribution pipe 163 from the liquid column 154 in order to minimize agitation of liquid extracted from the liquid column 154. The physical location of connections 150 and 155 are not restricted to a specific location on the tank and may be located so as to be easy to access the pipe connections from outside the tank. Pumps 164 may be constant or variable speed pumps.

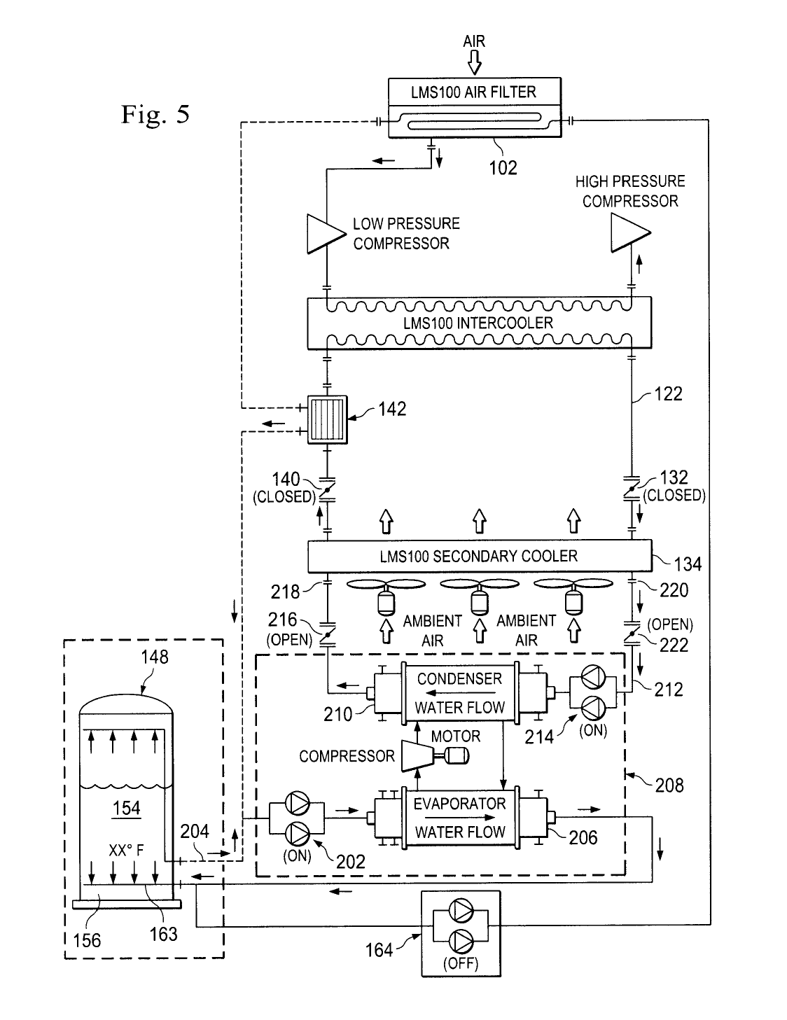

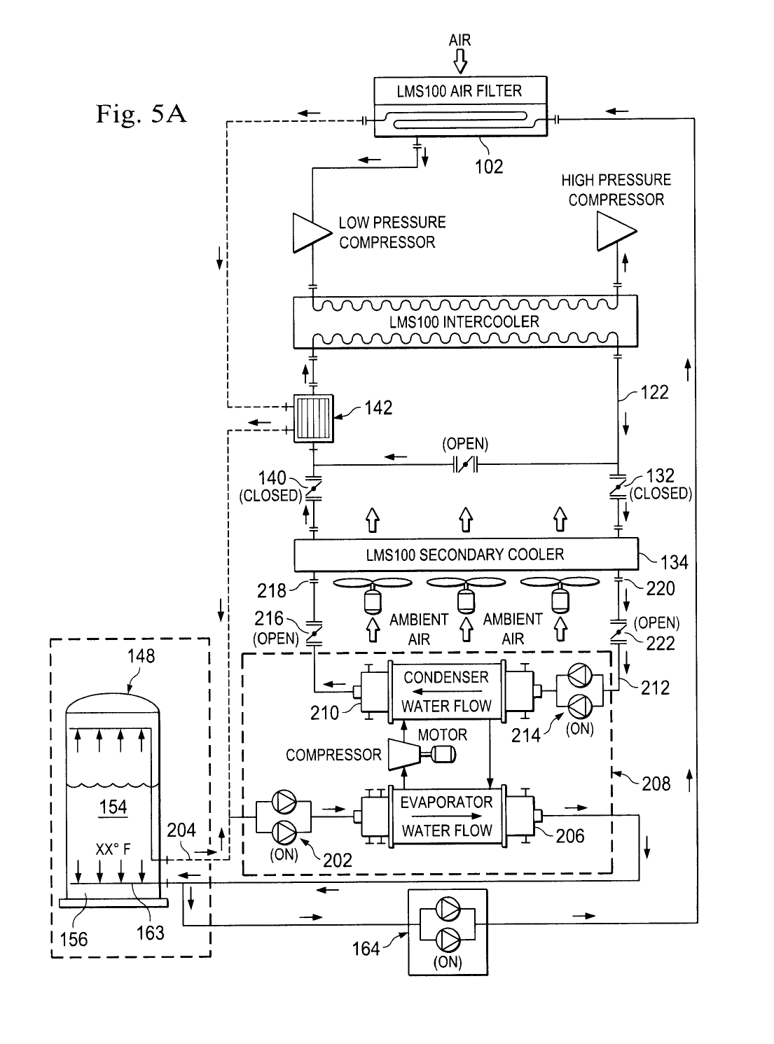

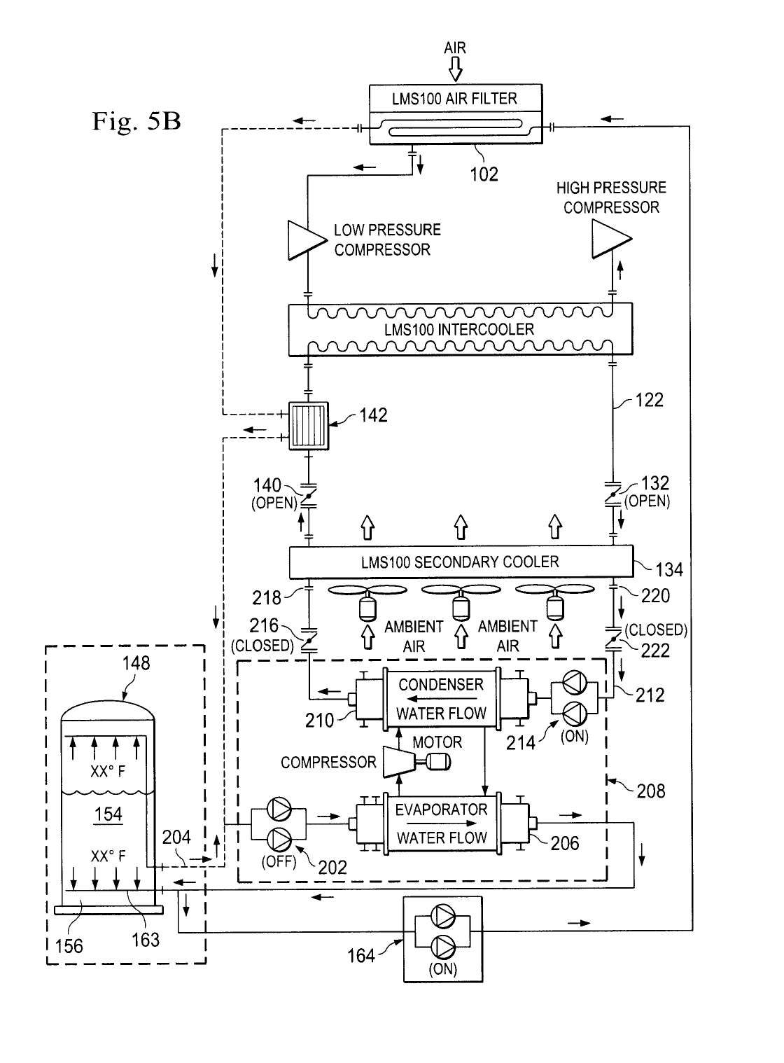

With reference to FIG. 5, after operating for a period of time to cool the gas turbine inlet air and/or to cool the intercooler cooling liquid 122, the liquid column 154 in the TES 148 will require recharging, i.e., cooling, since a large portion of the water in the TES 148 may have been warmed during the discharge period when the turbine was running. The amount of charge left in TES 148 can be measured by measuring the thermacline level 157 and as this height decreases the amount of charge remaining is also decreased. Preferably, the temperature of the liquid column 154 in the TES 148 is lowered during a TES charge cycle as illustrated in FIG. 5. During such a charge cycle, typically intercooled gas turbine system 100 (of FIG. 3) will be off-line or idle, which those of ordinary skill in the art will appreciate, most typically occurs at non-peak hours such as night time. In an exemplary embodiment, during the TES charge cycle, one or more chilled liquid pumps 202 operate to pump liquid 204 from near the top 158 of the liquid column 154 through one or more evaporators 206 of a chiller system 208. During a full charge cycle, such as shown in FIG. 5, pumps 164 will normally be off to allow all of the chilled water to be reintroduced into the TES 148. However, if the turbine is running, then the operator would have the option to run pumps 164 to allow some of the chilled water from the chiller system 208 and/or the TES 148 to continue to circulate to the inlet air cooling coil system 102 and/or to cool the intercooler cooling liquid 122 as shown in FIG. 5A. This would give the operator great flexibility as excess chilled water from the chiller system 208 may be used to partially charge the TES 148 even while simultaneously cooling of the turbine. Alternatively, the operator may chose to reduce the operation of the chiller system 208 to reduce power consumption and would therefore draw the additional chilled water from the TES 148 (partial discharge mode). If the operator wished to maximize the power output of the system, he may elect to turn off the chiller system entirely and provide cooling to the gas turbine and/or the intercooler from the TES 148 as shown in FIG. 5B. In that case, it may be desirable to cool some or all of the intercooler cooling liquid 122 with the second heat exchanger 134 since that would not be used by the chiller while the chiller is off. This would be accomplished by opening valves 140 and 132 while closing valves 216 and 222. This intercooler cooling liquid 122 may be further cooled if desired by the circulating liquid from the TES 148. Alternatively, pumps 164 may be turned off if the gas turbine system 100 is off-line. Although depicted as a single chiller in FIG. 5, chiller system 208 may include one or more chillers. Chiller system 208 may be centrifugal, rotary screw or absorption chillers, or any other type of water chiller, or any combination of these chillers. Chiller system 208 may be piped so that the evaporators of the chillers are in series or piped so that the evaporators are in parallel, or a combination of evaporators in series and evaporators in parallel. The centrifugal or rotary screw chillers may be driven by electric motors or steam turbines and the absorption chillers may be fired by natural gas, steam, or hot water. The liquid 204 is cooled in the evaporator(s) of chiller system 208. Preferably the chilled water is returned to the bottom 156 of the liquid column 154 in the tank 148. Alternatively, some or all of the chilled water may be used to cool the turbine inlet air as described above, or to cool the intercooler heat exchanger liquid as described above, or to cool the compressed air 118 as described in more detail below.

With reference to FIG. 5, chiller system 208 includes one or more condensers 210 through which condenser liquid 212 is circulated by one or more condenser liquid pumps 214. In an exemplary embodiment, one or more condenser liquid pumps 214 discharge condenser liquid 212 through the one or more condensers 210 of chiller system 208. Chiller system 208 may be piped so that the condensers of the chillers are in series or piped so that the condensers are in parallel, or a combination of condensers in series and condensers in parallel. After exiting the one or more condenser(s) 210 of chiller system 208, the condenser liquid 212 passes through a valve 216 and enters the second heat exchanger 134 at a second heat exchanger condenser liquid inlet 218. The condenser liquid 212 is then cooled in the second heat exchanger 134 and exits the second heat exchanger 134 at a second heat exchanger condenser liquid outlet 220 and passes through a valve 222 and then re-enters the one or more condenser liquid pumps 214. During operation of the chiller system 208 (see FIG. 5), the valves 132 and 140 of the intercooler heat exchanger cooling liquid system are typically closed while valves 216 and 222 open, although in some embodiments heat exchanger 134 may be configured to cool both condenser liquid 212 and intercooler heat exchanger liquid 122 at the same time.

The second heat exchanger 134 that provides the function of cooling the intercooler cooling liquid 122 during the operation of the gas turbine thus serves an additional function of cooling the condenser liquid 212 during the operation of the chiller system 208. Since these two modes of operation may often be at different times of the day, this allows the second heat exchanger to be utilized more fully which may results in the need for only a single second heat exchanger rather than two.

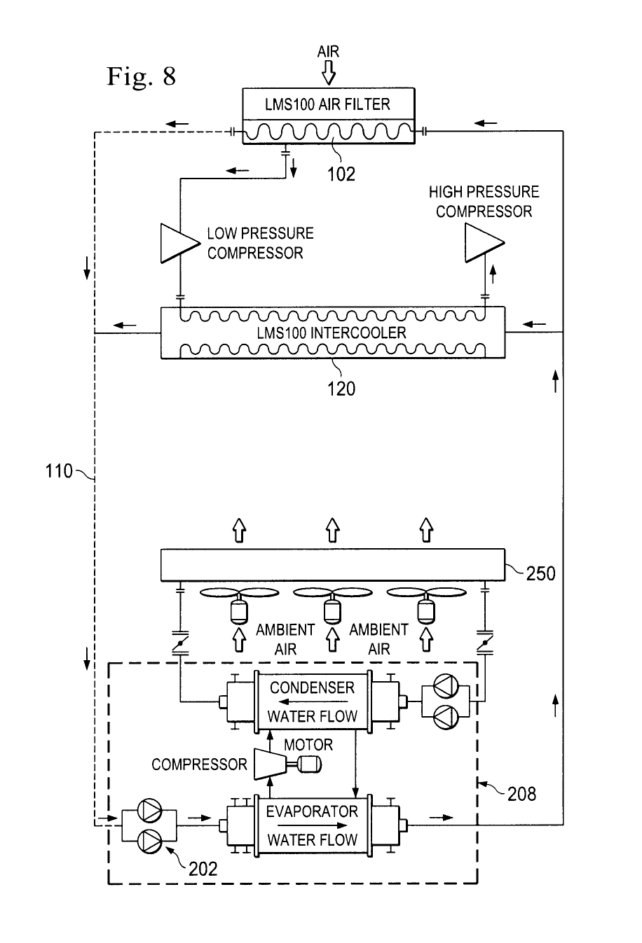

In another embodiment, as seen in FIG. 8A, the system operates similar to that depicted in FIG. 5 except the third heat exchanger 142 is not provided. This embodiment would not allow the circulating chilled water from chiller system 208 to be used to cool the intercooler, but it would allow the second heat exchanger 134 to be used to cool the condenser water 212 of the chiller system 208.

In another embodiment, as seen in FIG. 6, the condenser liquid 212 enters the second heat exchanger 134 through the same second heat exchanger inlet 136 as the intercooler cooling liquid 122. In this embodiment, the condenser liquid 212 exits the second heat exchanger 134 through the same second heat exchanger outlet 138 as the intercooler cooling liquid 122. As shown, valves and piping are arranged so that only a single liquid inlet and a single liquid outlet for heat exchanger 134 is necessary.

The TES charge cycle described above may be continued until the temperature of liquid column 154 has reached a desired temperature. In an exemplary embodiment, the TES charge cycle is performed during periods of time when the gas turbine is not in use. For example, the TES charge cycle may be performed at night when the demands for electrical power generation are less and the gas turbine may not be in operation.

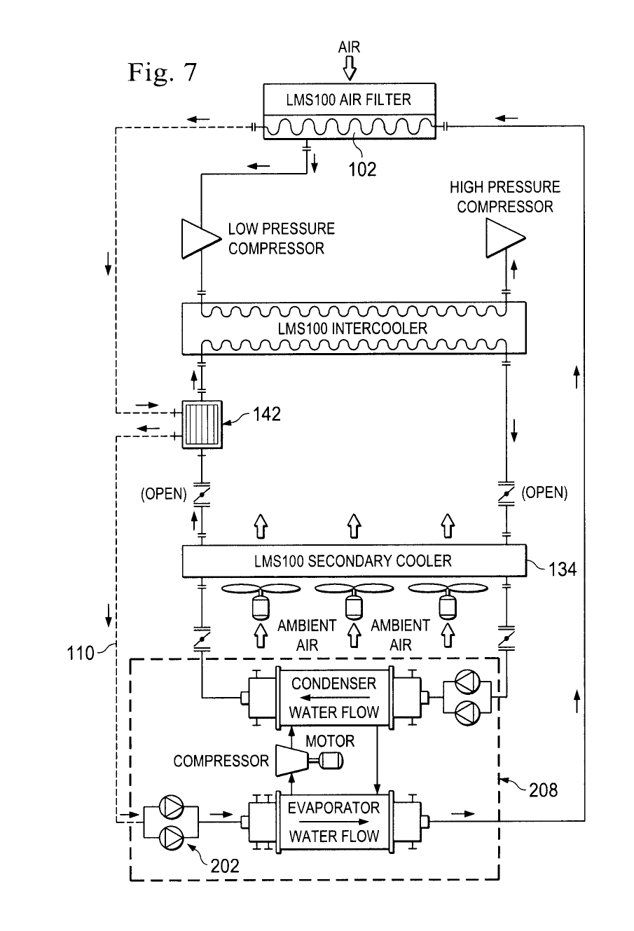

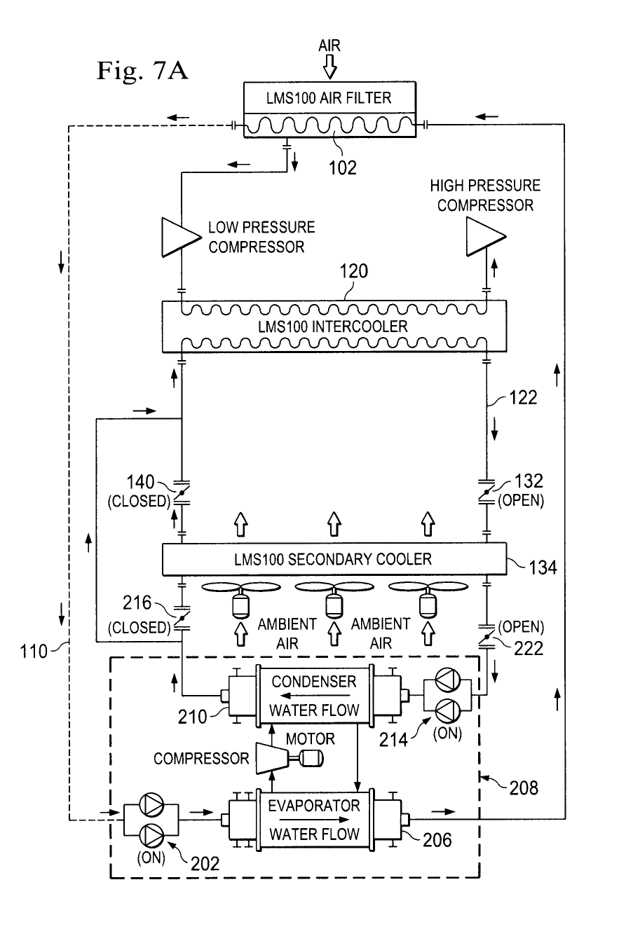

Referring to FIG. 7, in another embodiment, intercooled gas turbine system 100 does not include the TES 148. The chiller system 208 may be operated concurrently with the operation of the gas turbine 101 when it is desired to cool the inlet air to the gas turbine and/or cool the third heat exchanger 142. In this embodiment, chilled liquid pumps 164 would no longer be necessary, and chilled liquid pumps 202 would operate to pump return chilled liquid 110 through the evaporator(s) of chiller system 208 and to the inlet air cooling coil system 102.

In yet another embodiment (not shown,) as mentioned above, chilled liquid may be pumped directly to the third heat exchanger 142. In another embodiment (not shown,) as mentioned above, chilled liquid may be pumped to both the inlet air cooling coil system 102 and the third heat exchanger 142, either in parallel or in series. In one embodiment in which a TES is not incorporated into system 100, intercooled gas turbine system 100 includes the third heat exchanger 142, while in another embodiment, intercooled gas turbine system 100 does not include the third heat exchanger 142.

As mentioned above, in one embodiment where intercooled gas turbine 101 operates concurrently with the chiller system 208, a second heat exchanger 134 may be provided that is sized to handle the heat rejection for both the intercooler heat exchanger 120 and the condenser(s) 210 of the chiller system 208. In yet another alternative embodiment (not shown), chiller system 208 is provided with its own cooling tower system and does not utilize the second heat exchanger 120 for the rejection of the heat of the condenser(s) 210 of the chiller system 208.

In a preferred embodiment where no TES tank is used, the third heat exchanger may be omitted, as shown in FIG. 7A. In this embodiment, the warm intercooler cooling liquid 122 will be circulated to the second heat exchanger 134 where it will be cooled. The cooled liquid will continue on through the open valve 222 and then pass through the condenser of the chilling system 210. This partially warmed circulating fluid will then bypass the second heat exchanger 134 by the closed valve 216 and be routed to the intercooler heat exchanger 120 where it will be heated and then circulate back to the second heat exchanger 134 to repeat the cycle. This sequential heating of the circulating fluid (first through the chiller condenser 210 and then through the intercooler 120) will allow a higher temperature rise of the circulating fluid, increasing the effectiveness of the second heat exchanger 134 and allowing this second heat exchanger to be sized smaller than if this task were handled by two separate heat exchangers.

Referring to FIG. 8, in another embodiment, intercooled gas turbine system 100 does not include the second heat exchanger 134. Chilled liquid pumps 164 provide chilled liquid from the TES tank 148 to the chilled liquid inlet of the intercooler heat exchanger 120. In this embodiment, there is no need for intercooler cooling liquid 122. Rather the intercooler heat exchanger 120 cools the compressed air 118 with the chilled liquid provided directly from the TES tank 148. In this embodiment, chiller system 208 may be provided with its own cooling tower system 250, or other means of rejecting its condenser water heat, because there is no second heat exchanger 134. In another embodiment, chilled liquid pumps 164 provide chilled liquid from the TES tank 148 to the chilled liquid inlet of the intercooler heat exchanger 120 and to the inlet air cooling coil system 102.

In another embodiment and still referring to FIG. 8, the chiller system 208 may be operated concurrently with the operation of the gas turbine 101 and chilled liquid pumps 202 can operate to pump return chilled liquid 110 through the evaporator(s) of chiller system 208 and to the chilled liquid inlet of the intercooler heat exchanger 120. In this embodiment, there is no TES tank 148 and chilled liquid pumps 164 would no longer be necessary. In one embodiment, chilled liquid pumps 202 may provide chilled liquid to the chilled liquid inlet of the intercooler heat exchanger 120 and also to the inlet air cooling coil system 102

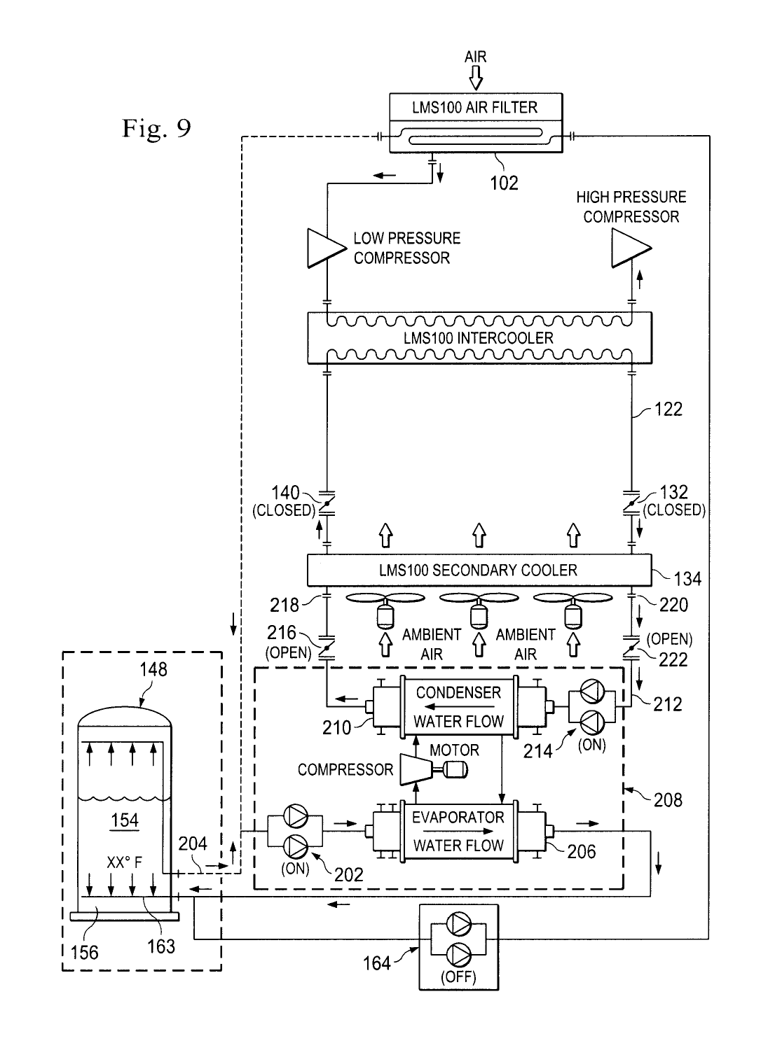

The next 3 embodiments would all utilize a TES tank but would not use a third heat exchanger 142 as a preferred method. FIG. 9 shows an embodiment where the TES tank is used to provide cooling fluid only to the inlet air cooling system 102 but not to the intercooler. This embodiment offers the advantage of dual use of the second heat exchanger 134 to be used as the heat rejection for the intercooler whenever the turbine is running while being able to switch over to be used as the heat rejection for the condenser 210 of the chiller system 208 whenever the turbine is not running.

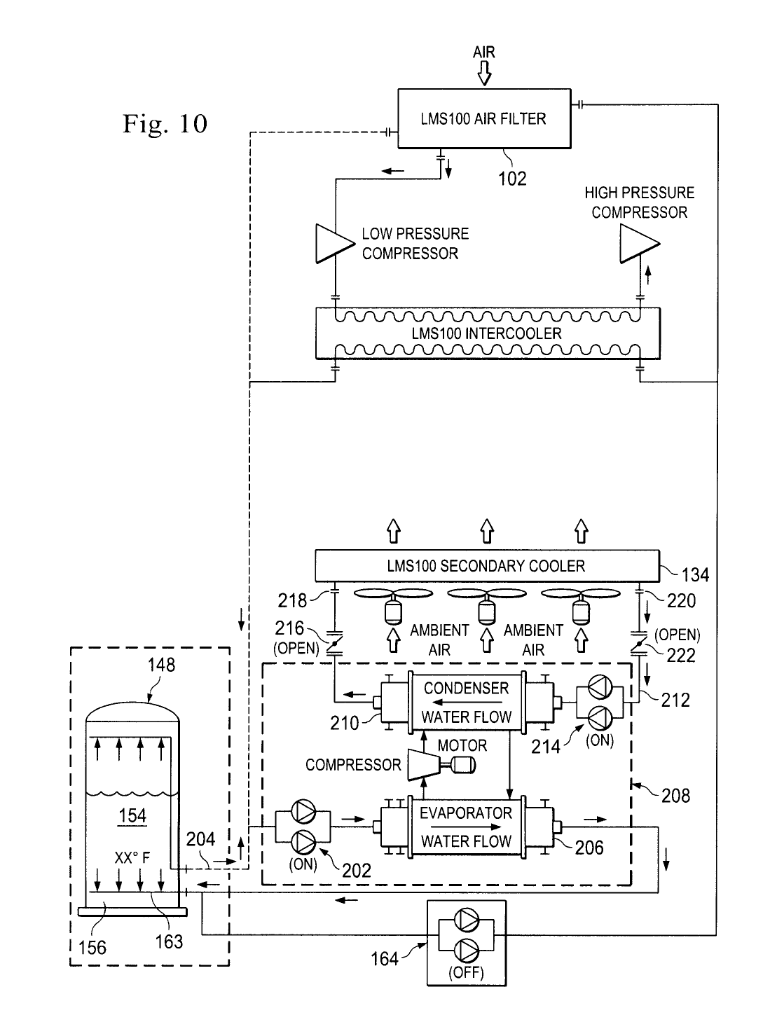

Referring to FIG. 10, the second heat exchanger is dedicated for use in heat rejection of the condenser 210 of the chiller system 208. In this embodiment, the intercooler will be reliant on the chilled liquid from the TES tank 148 and/or the chiller system 208 to provide the cooling for the intercooler. This embodiment would provide chilled liquid to both the intercooler as well as the inlet air cooling system 102 in parallel.

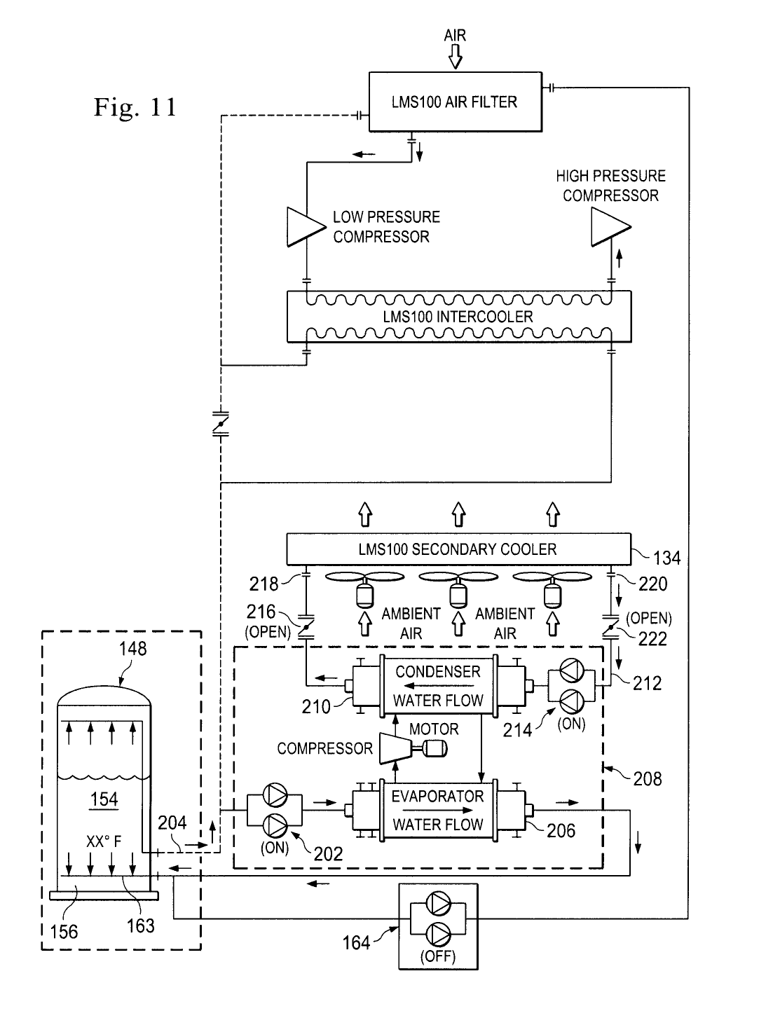

FIG. 11 shows a similar arrangement to FIG. 10 except the chilled liquid would feed the inlet air cooling system 102 first and then feed the intercooler second in a series arrangement. This represents a preferred method because this series arrangement allows the circulating fluid to be heated to a higher temperature which will improve the thermal storage capacity of TES tank 148 while also improving the efficiency of the chiller system 208, particularly if there are multiple chillers with the evaporators piped in series (not shown) which would be a preferred method on larger projects.

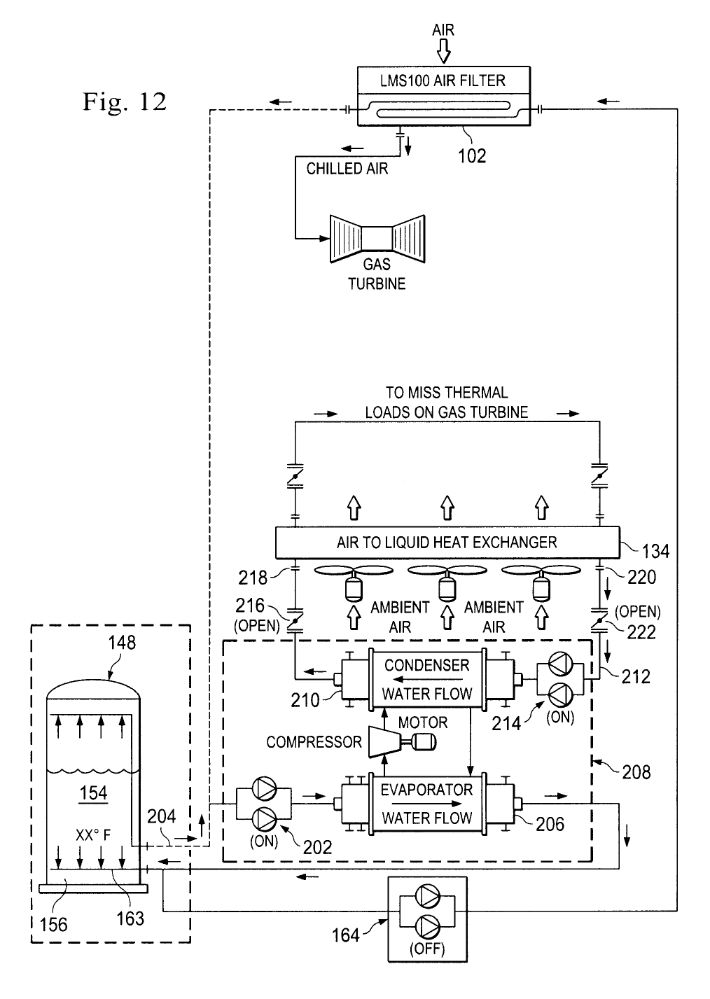

FIG. 12 shows an arrangement for a non-intercooled gas turbine. In this arrangement there is no intercooler, therefore the condenser 210 of the chiller will be piped to an air to liquid heat exchanger 134 which will be sized and dedicated primarily for the duty of the condenser. This example would be a preferred method for cooling the inlet air of a gas turbine whereby an inlet air cooling coil will be in fluid communication with the evaporator of a chiller and a thermal energy storage tank. Prior art chillers which have been used in Thermal Storage Turbine Inlet Cooling applications have used either water cooled chillers which reject heat to a cooling tower or they have been air-cooled chillers which rejected the heat from the refrigerant directly to the air in an air-cooled condenser. This specific embodiment would utilize a water cooled chiller which is available in larger sizes than air cooled chillers but it would utilize a closed loop circulating liquid (usually water with some additives) to circulate between the condenser of the chiller and the air to liquid exchanger. This would provide the water savings desired of the air-cooled chiller while preserving the ability to utilize a more standard water-cooled type chiller. This air to liquid exchanger could also be sized to handle additional cooling requirements of the gas turbine such as lube oil cooling, intercooling, generator cooling and similar type cooling needs. Further, since the chiller with the thermal storage tank has the option to only be operating when the turbine is not running, this same air to liquid heat exchanger may be utilized for the gas turbine auxiliary cooling needs when the turbine is running and then dedicated primarily or solely to the condenser when the turbine is not running. It is contemplated as a further improvement that a cooling tower may be located downstream or in parallel with the air to liquid heat exchanger. This would offer the ability to drop the temperature of the circulating liquid during certain peak temperature periods while still preserving most of the water-saving advantages of the air cooled heat exchanger.

It should be understood that embodiments of the invention can be practiced with modification and alteration within the spirit and scope of the appended claims. The description is not intended to be exhaustive or to limit the invention to the precise form disclosed.

While certain features and embodiments of the invention have been described in detail herein, it will be readily understood that the invention encompasses all modifications and enhancements within the scope and spirit of the following claims. Furthermore, no limitations are intended in the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A system for cooling the partially compressed air of a gas turbine compressor, said system comprising:
a gas turbine having a first compression section with an air inlet and an air outlet and a second compression section with an air inlet and an air outlet;
an intercooler heat exchanger having an air inlet, an air outlet, a liquid inlet and a liquid outlet, wherein the intercooler heat exchanger air inlet is in fluid communication with the first compression section air outlet and wherein the intercooler heat exchanger air outlet is in fluid communication with the second compression section air inlet and wherein an intercooler cooling liquid transfers heat from said intercooler to a second heat exchanger;
a second heat exchanger having a first liquid inlet and a first liquid outlet, wherein the second heat exchanger first liquid inlet is in fluid communication with the intercooler heat exchanger liquid outlet and the second heat exchanger first liquid outlet is in fluid communication with the intercooler heat exchanger liquid inlet; and
a chiller having a condenser liquid inlet and a condenser liquid outlet and an evaporator liquid inlet and an evaporator liquid outlet, wherein said condenser liquid inlet is in fluid communication with said second heat exchanger first liquid outlet and said condenser liquid outlet is in fluid communication with said heat exchanger first liquid inlet.

2. The system of claim 1, where said evaporator liquid outlet is in fluid communication with the intercooler heat exchanger liquid inlet.

3. The system of claim 1, where said evaporator liquid outlet is in fluid communication with a third heat exchanger which can provide heat transfer with the intercooler cooling liquid which circulates between the intercooler and the second heat exchanger.

4. The system of claim 1, where the evaporator liquid outlet is in fluid communication with a gas turbine inlet air cooling coil.

5. The system of claim 1, further comprising a thermal energy storage tank containing a liquid column characterized by a top and a bottom, said thermal energy storage tank having a first fluid port in communication with the top of the liquid column and a second fluid port in communication with the bottom of the liquid column, wherein said first fluid port is in fluid communication with said evaporator liquid inlet and the second fluid port is in fluid communication with said evaporator liquid outlet.

6. The system of claim 5, wherein the second fluid port is in fluid communication with the intercooler heat exchanger liquid inlet.

7. The system of claim 5, wherein the first fluid port is in fluid communication with the intercooler heat exchanger liquid outlet.

8. The system of claim 5, wherein the second fluid port is in fluid communication with the intercooler heat exchanger liquid inlet and the first fluid port is in fluid communication with the intercooler heat exchanger liquid outlet.

9. The system of claim 1, further comprising a third heat exchanger having a first liquid inlet and a first liquid outlet and a second liquid inlet and a second liquid outlet, wherein the third heat exchanger first liquid inlet and first liquid outlet are disposed in line between the second heat exchanger first liquid outlet and the intercooler heat exchanger liquid inlet.

10. The system of claim 9, wherein the evaporator liquid outlet is in fluid communication with the third heat exchanger second liquid inlet and the third heat exchanger second liquid outlet is in fluid communication with the evaporator liquid inlet.

11. The system of claim 5, further comprising a third heat exchanger having a first liquid inlet and a first liquid outlet and a second liquid inlet and a second liquid outlet, wherein the third heat exchanger first liquid inlet and first liquid outlet are disposed in line between the second heat exchanger first liquid outlet and the intercooler heat exchanger liquid inlet.

12. The system of claim 11, wherein the thermal energy storage tank second fluid port is in fluid communication with the third heat exchanger second liquid inlet and the thermal energy storage tank first fluid port is in fluid communication with the third heat exchanger second liquid outlet.

12. The system of claim 1, wherein the chiller is a mechanical centrifugal chiller.

13. The system of claim 1, wherein the chiller is a mechanical rotary screw chiller.

14. A system for cooling the partially compressed air of a gas turbine compressor, said system comprising:
a gas turbine having a first compression section with an air inlet and an air outlet and a second compression section with an air inlet and an air outlet;
an intercooler heat exchanger having an air inlet, an air outlet, a liquid inlet and a liquid outlet, wherein the intercooler heat exchanger air inlet is in fluid communication with the first compression section air outlet and wherein the intercooler heat exchanger air outlet is in fluid communication with the second compression section air inlet; and
a chiller having a condenser liquid inlet and a condenser liquid outlet and an evaporator liquid inlet and an evaporator liquid outlet, wherein the evaporator liquid inlet is in fluid communication with the intercooler heat exchanger liquid outlet and the evaporator liquid outlet is in fluid communication with the intercooler heat exchanger liquid inlet.

15. The system of claim 14 further comprising a thermal energy storage tank containing a column of liquid characterized by a top and a bottom, said thermal energy storage tank having a first fluid port in communication with the top of the liquid column and a second fluid port in communication with the bottom of the liquid column, wherein said first fluid port is in fluid communication with said intercooler heat exchanger liquid outlet and the second fluid port is in fluid communication with said intercooler heat exchanger liquid inlet.

16. The system of claim 15, wherein the second fluid port is in fluid communication with a gas turbine inlet air cooling coil.

17. A system for cooling the partially compressed air of a gas turbine compressor, said system comprising:
a gas turbine having a first compression section with an air inlet and an air outlet and a second compression section with an air inlet and an air outlet;
an intercooler heat exchanger having an air inlet, an air outlet, a liquid inlet and a liquid outlet, wherein the intercooler heat exchanger air inlet is in fluid communication with the first compression section air outlet and wherein the intercooler heat exchanger air outlet is in fluid communication with the second compression section air inlet; and
a thermal energy storage tank containing a column of liquid characterized by a top and a bottom, said thermal energy storage tank having a first fluid port in communication with the top of the liquid column and a second fluid port in communication with the bottom of the liquid column, wherein said first fluid port is in fluid communication with said intercooler heat exchanger liquid outlet and the second fluid port is in fluid communication with said intercooler heat exchanger liquid inlet

18. The system of claim 17 further comprising a chiller having a condenser liquid inlet and a condenser liquid outlet and an evaporator liquid inlet and an evaporator liquid outlet, wherein the evaporator liquid inlet is in fluid communication with the first fluid port and the evaporator liquid outlet is in fluid communication with the second fluid port of said thermal energy storage tank.

19. A system for cooling the partially compressed air of a gas turbine compressor, said system comprising:
a gas turbine having a first compression section with an air inlet and an air outlet and a second compression section with an air inlet and an air outlet;
an intercooler heat exchanger having an air inlet, an air outlet, a liquid inlet and a liquid outlet, wherein the intercooler heat exchanger air inlet is in fluid communication with the first compression section air outlet and wherein the intercooler heat exchanger air outlet is in fluid communication with the second compression section air inlet; and
a thermal energy storage tank containing a column of liquid characterized by a top and a bottom, said thermal energy storage tank having a first fluid port in communication with the top of the liquid column and a second fluid port in communication with the bottom of the liquid column, wherein said first fluid port is in fluid communication with the outlet of a third heat exchanger which may transfer heat from an intercooler cooling liquid which transfers heat from the intercooler heat exchanger.

20. The system of claim 19 wherein the chilled liquid from the thermal energy storage tank is used to cool the intercooler cooling liquid and the gas turbine inlet air cooling coil.

21. The system of claim 20 wherein the chilled liquid is first used to cool the gas turbine inlet air cooling coil and then the intercooler cooling liquid before going back to the thermal energy storage tank.

22. The system of claim 1, wherein there are multiple liquid inlets of the second heat exchanger.

23. The system of claim 1, wherein there are multiple liquid outlets of the second heat exchanger.

24. A method for cooling the partially compressed air of a gas turbine compressor, said method comprising:
providing a gas turbine having a first air compression section and a second air compression section;
providing an intercooler heat exchanger in fluid communication with the air compression sections of the gas turbine;
providing a second heat exchanger in fluid communication with the intercooler heat exchanger;
providing a chiller having a condenser in fluid communication with the second heat exchanger,
during operation of the gas turbine, removing partially compressed air from the first compression section, passing a portion of the removed, partially compressed air through the intercooler heat exchanger to lower the temperature of the removed, partially compressed air by heat exchange with a heat transfer liquid circulating between said intercooler heat exchanger and said second heat exchanger, thereby raising the temperature of the heat transfer liquid, introducing the cooled, partially compressed air into the second compression section of the gas turbine, and introducing the heated heat transfer liquid into the second heat exchanger; and
when the gas turbine is not operating, circulating a heat transfer liquid from a condenser of a chiller, passing a portion of the circulating heat transfer liquid through the second heat exchanger to lower the temperature of the circulating heat transfer liquid, then introducing the cooled, heat transfer liquid back to the condenser.

25. The method of claim 24, further comprising providing a thermal energy storage tank containing a column of liquid characterized by a top and a bottom, said thermal energy storage tank having a first fluid port in communication with the top of the liquid column and a second fluid port in communication with the bottom of the liquid column, wherein said first fluid port is in fluid communication with said evaporator liquid inlet and the second fluid port is in fluid communication with said evaporator liquid outlet.

26. A method for cooling the partially compressed air of a gas turbine compressor, said method comprising:
providing a gas turbine having a first air compression section and a second air compression section;
providing an intercooler heat exchanger in fluid communication with the air compression sections of the gas turbine;
providing a liquid-to-liquid heat exchanger in fluid communication with the intercooler heat exchanger;
providing a thermal energy storage tank in fluid communication with the liquid-to-liquid heat exchanger, said thermal energy storage tank containing a column of liquid characterized by a top and a bottom; and
during operation of the gas turbine, removing partially compressed air from the first compression section, passing a portion of the removed, partially compressed air through the intercooler heat exchanger to lower the temperature of the removed, partially compressed air by heat exchange with a heat transfer liquid circulating between said intercooler heat exchanger and said liquid-to-liquid heat exchanger, thereby raising the temperature of the heat transfer liquid, introducing the cooled, partially compressed air into the second compression section of the gas turbine, and passing a portion of the heated heat transfer liquid through the liquid-to-liquid heat exchanger to lower the temperature of the heated heat transfer liquid by heat exchange with chilled liquid from the thermal energy storage tank.

27. A method for cooling the partially compressed air of a gas turbine compressor, said method comprising:
providing a gas turbine having a first air compression section and a second air compression section;
providing an intercooler heat exchanger in fluid communication with the air compression sections of the gas turbine;
providing a liquid-to-liquid heat exchanger in fluid communication with the intercooler heat exchanger;
providing a chiller having an evaporator in fluid communication with the liquid-to-liquid heat exchanger; and
during operation of the gas turbine, removing partially compressed air from the first compression section, passing a portion of the removed, partially compressed air through the intercooler heat exchanger to lower the temperature of the removed, partially compressed air by heat exchange with a heat transfer fluid circulating between said intercooler heat exchanger and said liquid-to-liquid heat exchanger, thereby raising the temperature of the heat transfer fluid, introducing the cooled, partially compressed air into the second compression section of the gas turbine, and passing a portion of the heated heat transfer fluid through the liquid-to-liquid heat exchanger to lower the temperature of the heated heat transfer fluid by heat exchange with liquid from the evaporator before circulating the liquid back to the condenser.

28. A method for cooling the partially compressed air of a gas turbine compressor, said method comprising:
providing a gas turbine having a first air compression section and a second air compression section;
providing an intercooler heat exchanger in fluid communication with the air compression sections of the gas turbine;
providing a chiller having an evaporator and a condenser; and
during operation of the gas turbine, removing partially compressed air from the first compression section, passing a portion of the removed, partially compressed air through the intercooler heat exchanger to lower the temperature of the removed, partially compressed air by heat exchange with liquid leaving the condenser, thereby raising the temperature of the circulating liquid, introducing the cooled, partially compressed air into the second compression section of the gas turbine, and taking the warmed circulating liquid leaving the intercooler and cooling it in a second heat exchanger.

29. The method of claim 28 wherein the chilled liquid leaving the evaporator is in fluid communication with the gas turbine inlet air cooling coil.

30. The method of claim 28, further comprising providing a thermal energy storage tank in fluid communication with the evaporator and the gas turbine inlet air cooling coil, said thermal energy storage tank containing a column of liquid characterized by a top and a bottom, wherein the liquid cooled by the chiller is stored in the thermal energy storage tank prior to introduction into the gas turbine inlet air cooling coil.

31. A method for cooling the inlet air of a gas turbine compressor, said method comprising:
providing a gas turbine having a first air compression section and a second air compression section;
providing an intercooler heat exchanger in fluid communication with the air compression sections of the gas turbine;
providing a second heat exchanger in fluid communication with the intercooler heat exchanger;
providing a thermal energy storage tank in fluid communication with gas turbine inlet air cooling coil, said thermal energy storage tank containing a column of liquid characterized by a top and a bottom;
during operation of the gas turbine, removing partially compressed air from the first compression section, passing a portion of the removed, partially compressed air through the intercooler heat exchanger to lower the temperature of the removed, partially compressed air by heat exchange with a heat transfer liquid circulating between said intercooler heat exchanger and said second heat exchanger, thereby raising the temperature of the heat transfer liquid, introducing the cooled, partially compressed air into the second compression section of the gas turbine, and passing a portion of the heated heat transfer liquid through the second heat exchanger to lower the temperature of the heated heat transfer liquid; and
when the gas turbine is not operating, circulating heat transfer liquid from the condenser to the second heat exchanger and then back to the condenser and circulating a portion of chilled liquid from the evaporator of the chiller to a thermal energy storage tank.

32. A method for cooling the inlet air of a gas turbine, said method comprising:
providing an inlet air cooling coil in fluid communication with the evaporator of a chiller:
providing a thermal energy storage tank in fluid communication with gas turbine inlet air cooling coil and the evaporator of said chiller, said thermal energy storage tank containing a column of liquid comprised primarily of water, said tank characterized by a top and a bottom;
providing a liquid to air heat exchanger which will be in fluid communication with the condenser of said chiller;
when chiller is operating, pumping a separate heat transfer liquid through the condenser and then through said liquid to air heat exchanger to cool the heat transfer liquid by means of heat transfer with the ambient air at said liquid to air heat exchanger and then circulating cooled heat transfer liquid back to said condenser;
when the gas turbine is not operating, circulating water from near the top of the thermal storage tank to the evaporator of said chiller to drop its temperature, then routing some or all of the water back to near the bottom of the thermal storage tank; and
during certain times of the day or year when the ambient temperature is above approx 50 F and the gas turbine is operating, circulating a portion of water from near the bottom of the thermal storage tank to the gas turbine inlet air cooling coil and then circulating that portion of water back to near the top of the thermal storage tank.

33. The method of claim 32 wherein when the turbine is operating, the liquid to air heat exchanger is used to cool one or more components associated with the gas turbine.

34. The method of claim 32 wherein when the turbine is not operating, the largest amount of cooling from the liquid to air heat exchanger is dedicated to the condenser of said chiller.

35. The method of claim 32 wherein when the turbine is operating, the largest amount of cooling from the liquid to air heat exchanger is dedicated to auxiliary equipment associated with the gas turbine but not the condenser of said chiller
